(19) United States
(12) Patent Application Publication
(10) Pub. No.: US 2025/0045421 A1
(43) Pub. Date: Feb. 6, 2025

(54) Apparatus and Method for Operating System Agnostic Data Encryption

(71) Applicant: Sertainty Corporation, Nashville, TN (US)

(72) Inventors: Richard STREETER, Lebanon, TN (US); Gregory Scott SMITH, Madison, TN (US); Daniel Michael FISCHER, Brentwood, TN (US)

(21) Appl. No.: 18/362,326

(22) Filed: Jul. 31, 2023

(51) Int. Cl. G06F 21/60; H04L 9/06

(52) U.S. Cl. CPC G06F 21/602; H04L 9/06

(57) ABSTRACT

In an embodiment, an apparatus where encrypted data is agnostic to encryption functionality controlled by the operating system is presented. The apparatus includes a processor and memory communicatively connected to the processor. The memory includes instructions configuring the processor to receive encrypted input data for processing by an application. The processor is configured to store the encrypted input data in a communications input buffer immediately after receipt. The OS through predetermined functionality then determines where the ultimate intended destination that data in the communications input buffer should be, moves the data to that location, referred to as the application input buffer. The processor is configured to execute the receiving application. The application is configured to run one or more programs utilizing the unencrypted input data to produce output data. The application is similarly configured to internally to optionally encrypt the output data to produce encrypted output data.

### TECHNICAL FIELD

This disclosure relates to apparatuses and methods for data encryption. In particular, the current disclosure relates to decryption of data agnostic to an operating system (OS) but under the control of an application controlled by the OS.

### BACKGROUND

Modern encryption techniques can leave unencrypted data in vulnerable states from a cybersecurity perspective. For instance, modern encryption techniques can leave unencrypted input and output data used by applications and programs in an unprotected state while the input waits to be accessed by the processing application and/or the output is moved a permanent location.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an embodiment, an apparatus where encrypted data is agnostic to encryption functionality controlled by the operating system is presented. The apparatus includes a processor and memory communicatively connected to the processor. The memory includes instructions configuring the processor to receive encrypted input data for processing by an application. The processor is configured to store the encrypted input data in a communications input buffer immediately after receipt. The OS through predetermined functionality then determines where the ultimate intended destination that data in the communications input buffer should be, moves the data to that location, referred to as the application input buffer. The processor is configured to execute the receiving application. That application is configured to receive the input as encrypted input data from the application input buffer. The application is configured to internally decrypt the encrypted input data and store it in the application's internal input buffer for use by the application's internal programming. The application is configured to run one or more programs utilizing the unencrypted input data to produce output data. The application is similarly configured to internally to optionally encrypt the output data to produce encrypted output data. The application is configured to store the encrypted output data in a corresponding external output buffer. At that point once again, the data waits for another OS function to move that data on to its final destination as it normally occurs.

In another embodiment, a method for operating system agnostic data encryption using a computing device is presented. The method includes receiving encrypted input data for processing by an application. The method includes storing the encrypted input data in an application input buffer, the application input buffer being a directory reserved for use by the application but controlled by the OS. The method includes executing the application. While executing, the application receives the encrypted input data from the application input buffer. The application's execution includes decrypting the input data to produce unencrypted input data. Executing the application includes running one or more programs with the unencrypted input data to produce output data. Executing the application also includes optionally encrypting the output data to produce encrypted output data that is then stored as encrypted output data in an application output buffer where responsibility for further transport reverts back to the OS.

### BRIEF DESCRIPTION OF THE DRAWINGS

The foregoing aspects and many of the attendant advantages of embodiments of the present disclosure will become more readily appreciated as the same become better understood by reference to the following detailed description, when taken in conjunction with the accompanying drawings.

FIG. 1 shows a diagram of an exemplary embodiment of an apparatus for data encryption.

FIG. 2 shows a flowchart of an exemplary embodiment of a method of data decryption and encryption through the application shown in FIG. 1.

FIG. 3 shows a computing system that can be implemented in any system, process, or method as described throughout this disclosure.

### DETAILED DESCRIPTION OF EXEMPLARY EMBODIMENTS

All applications, and the compilers that construct those applications tend to have an internal limitation, where there is a requirement that input data presented to an application needs to be unencrypted when ingested by the application. This data is almost always unencrypted by functionality outside the application, then the unencrypted data is stored in a directory referred to as an input buffer, where the now exposed unencrypted data resides until moved. The time the unencrypted data resides in that directory creates a cybersecurity threat vector where that data is readily available any person or process having either a legitimate or illegitimate access to that input buffer/directory. All the same is true in reverse with the application's output data. That data, whether one byte or several terabytes, is potentially exposed to non-intended actors while it remains in those input or output buffers. The data may be stored within that input or output buffer for various periods of time, such as milliseconds, seconds, minutes, hours, and the like, in which the data may be vulnerable. Advantageously, an aspect of the present disclosure provides an application-specific data encryption method that allows the input data to remain in an encrypted state when not being actively utilized by the application. Another advantage attained through this disclosure is during this process, the data in its unencrypted form can exist in the apparatus' random-access memory (RAM), and never needs to exist within a temporary file controlled by the OS that opens further potential data insecurities.

Another aspect of the present disclosure can be used to keep input data encrypted throughout one or more programs of an application running with the input data as input. While the input data may run through a decryption process, afterwards it is still in an encrypted state. In today's state-of-the-art the data is transformed into a clear text state and remains that way as it is moved between internal locations to be subsequently used by an application. This is a point of vulnerability in which aspects of the present disclosure may eliminate.

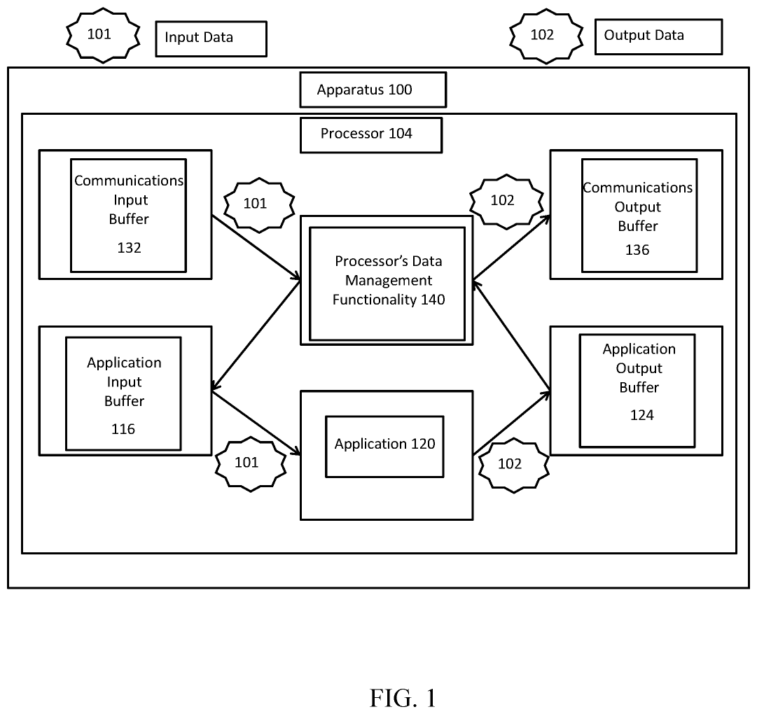

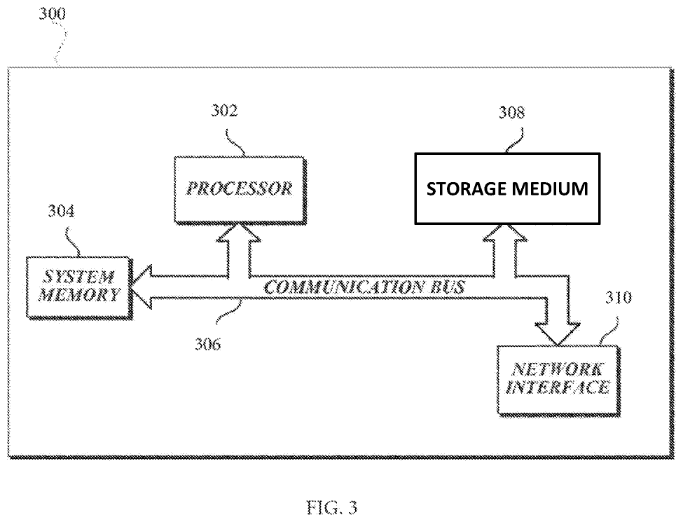

Referring now to FIG. 1, apparatus 100 for operating system agnostic data encryption is presented. The apparatus may include disk storage and/or internal memory, each of which may be communicatively connected to each other. Apparatus 100 includes at least one processor 104. The processor(s) 104 may enables both generic operating system (OS) functionality and/or application operations. In an embodiment, the apparatus 100 includes a RAM component. The memory may include instructions configuring the processor 104 to perform various tasks. The apparatus 100 may include a computing device 300, such as described below with reference to FIG. 3.

The processor 104 may be configured to receive input data 101 and place the input data into an communications input buffer 132. The processor 104 may receive input data 101 through a wired, wireless, or other connection. The processor 104 may receive the input data 101 from within a memory of the apparatus 100 and/or from an external computing device. For instance, the processor 104 may pull the input data 101 from one or more directories or other storage locations of the apparatus 100. The input data 101 may include one or more bytes encrypted through, but not limited to, symmetric-key, public-key, and/or other encryption systems. For instance, and without limitation, encryption algorithms that may be used include Advanced Encryption Standard (AES), Data Encryption Standard (DES), Triple DES (3DES), Ascon, Blowfish, Twofish, RSA, Elliptic Curve Cryptography (ECC), Diffie-Hellman (DH), Digital Signature Algorithm (DSA), or even proposed quantum safe algorithms such as CRYSTALS-Dilithium, Falcon, SPHINCS+, and any other algorithms intended to replace elliptical-curve based encryption within the PKI framework that may be approved. The input data 101 may be encrypted through any form of encryption as described throughout this disclosure, without limitation. In some embodiments, the input data 101 residing within the communications input buffer 132 may include and/or be an object data type. The input data 101 may include an object data type that may include, without limitation, data, permissions, encryption keys, and the like. In some embodiments, the input data 101 may include information such as, but not limited to, usernames, application data, passwords, photos, metadata, videos, documents, and/or other information the application 120 may eventually use as input to its processes. The input data 101 may additionally or alternatively include data such as characters, strings, text, symbols, and the like. In some embodiments, the input data may be in a specific file format. For instance, the input data may be in a csv, txt, doc, docx, xlsx, and/or other file type, without limitation. Contents of the input data 101 may be unknown to the processor 104 and may only be known to the application 120, as described below. In some embodiments, the input data 101 may include a self-controlling intelligent cipher transfer object (ICTO), such as described in U.S. application Ser. No. 17/377,595, filed Jul. 16, 2021, and titled “System and Methods for using Cipher Objects to Protect Data”, of which is incorporated by reference herein in its entirety.

The apparatus 100 may further include a communications input buffer 132, communications output buffer 136, application input buffer 116, and/or application output buffer 124. The communications input buffer 132, communications output buffer 136, application input buffer 116, and/or application output buffer 124, which may be collectively referred to as I/O buffers, may all be sub parts of a hierarchical directory structure, referred to as directories, that are controlled by the OS of the apparatus 100, and whose contents are available to users and processes based on permissions set by system administrators and others users who have elevated privileges, those privileges are sometimes referred to as “root level access”. An OS may manage all the functions on the apparatus 100. The physical location of the I/O buffers may be associated with the apparatus 100, but may also be remote, in some embodiments. Those skilled in the art, upon reading this disclosure, will appreciate the numerous mechanisms to make remote directories appear to the OS as part of the apparatus 100. Any suitable system or process may be implemented to make remote directories appear to the OS as part of the apparatus 100, without limitation.

The input data may initially, in some embodiments, initially reside and/or be located in an communications input buffer 132. The communications input buffer 132 may reside in a storage system of the apparatus 100, where the application 120 is not granted access. In some embodiments, the communications input buffer 132 may be application agnostic. “Application agnostic” as used in this disclosure refers to a form of data and/or data storage that is independent of one or more applications. An “input buffer” as used in this disclosure is a directory a computing device can access that holds incoming information before it continues for further processing. A digital storage device or service having a form of non-volatile storage may include, without limitation, an internal hard drive, a remote network drive, a cloud storage area, and/or other types of computing devices or services. An input buffer, such as the communications input buffer 132 and/or application input buffer 116, may be a directory location controlled by an operating system's data management system. As a non-limiting example, in a Windows system, an encrypted input data file would cause an entry in a Master File Table (MFT) and in the MFT the directory associated with the MFT is the communications input buffer 132. An input buffer, such as the application input buffer 116 and/or the communications input buffer 132, may be configured to store user input from a variety of user input devices, such as those described above. The application input buffer 116 may be configured to hold or otherwise contain data for use in the application 120. For instance, and without limitation, the application input buffer 116 may be configured to specifically be used as input by the application 120 for a period of time. Further there is no limitation that would preclude some data in the input buffer 116 that remains in an encrypted state coexisting with other data files intended for use by the application that are in an unencrypted state.

The processor 104 may have multiple and varied data management functionalities 140. The data management functionalities 140 of the processor 104 may manage a movement of file from the communications input buffer 132 to the application input buffer 116. This data management functionality 140 of the processor 104 may be responsive to and/or implement a time-based poll, a listener or other trigger that may cause the data management system to move one or more files form the communications input buffer 132 to the application input buffer 116. In some embodiments, once the input data is placed in the application input buffer 116, a triggering action by the data management functionality 140, similar to the trigger described above, may occur. If a trigger criterion is met, an operating system of the apparatus 100 may invoke a call to activate the application 120 to execute its functionality. To those skilled in the computer programming art, upon reading this disclosure, will understand the many methods and variations to accomplish the above-described task.

In some embodiments, data in the communications input buffer 132 and/or the communications output buffer 136 may be in a protected state. For instance, data in the communications input buffer 132 and/or the communications output buffer 136 may include one or more encrypted objects and/or files. In some embodiments, the same file and/or data object may be used for both the encrypted input data file 101 and the output data file 102. For instance, the encrypted input data 101 may include data from a data object, which may be accessed and executed by the application 120. The result of the execution of the application 120, such as the output data 102, may be placed back into an original data object, data file 101. In some embodiments, a completely new data object may be created to store the output data. In some embodiments, the application 120 may summon function calls to retrieve, or pull, the input data 101 from the communications input buffer 132 rather than an OS and/or network pushing the input data to the application. Function calls may include retrieving one or more values and/or variables, storing one or more values and/or variables, and/or other function calls. By having the application 120 summon function calls for the encrypted input data 101, the data of the encrypted input data 101 may be hidden from an OS and/or network and may only be briefly known to the application 120.

In some embodiments, the application 120 may generate one or more virtual files as a subset of the input data 101 and/or the output data 102. A “virtual file” as used in this disclosure is a digital abstraction of a concrete file which exists within RAM. A virtual file generated by the application 120 may include a temporary file, which oftentimes by convention utilizes the “.tmp” file extension. One or more virtual files may be used in any processes as described throughout this disclosure, without limitation. For instance, the application 120 may generate a virtual file of data of the encrypted input data 101 and use the virtual file as secondary input upon discretion of the application's programmer. In other embodiments, a separate output file 102 may exist at the same time, in those circumstances virtual temporary file could exist as products of either file, or both files simultaneously, again at the programmer's discretion. In some embodiments, a virtual file may be used temporarily by the application 120. For instance, one or more interim virtual files may be used as input for the application 120. The one or more interim virtual files may be deleted and/or erased after the application 120 executes. In other embodiments that same temporary processing file could be retained in the data object for future indeterminate processing or forensics.

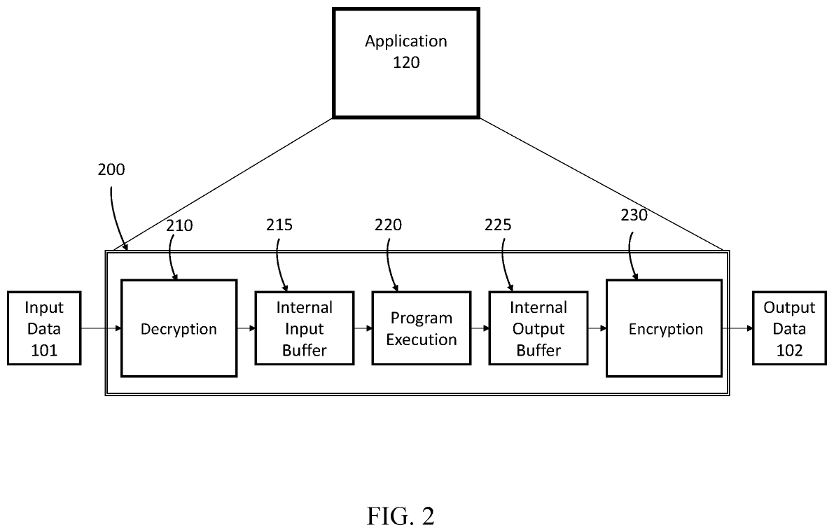

Referring now to FIG. 2, a method of data encryption and decryption within the application 200 is presented. The input data 101 is made available to the application 200, through processes as described above with reference to FIG. 1. In some embodiments, when the application 200 begins execution, the input data 101, still in an encrypted form, may be ingested into the application 120. The input data 101 may remain encrypted as it originally was when it was first brought into the communications input buffer 136.

At step 210, in some embodiments, any and all decryption and ancillary protection mechanisms may be removed once the input data 101 has been transferred into the application's 200 control. Once in the application's 200 control, the application may decrypt the input data 101, which may still be in an encrypted form. Decryption may include, without limitation, symmetric decryption, asymmetric decryption, hashing, and/or any other form of decryption, without limitation.

At step 215, the decrypted input data from step 210 is stored in an internal memory that may be defined and only accessible to the application 200. In step 215, the now decrypted data of the input data 101 is available per the program's execution 210, in a line-by-line iteration. The internal input buffer 215 may store one or more portions of unencrypted data from the input data 101. The internal data of the input data 101 may be made accessible to the application 200. The input data 101 at this step may be unencrypted and available to one or more operations as part of the programmatic execution 220 which are all at the discretion of the programmer. In some embodiments, the input data 101 may remained encrypted until the program execution 220 makes a call to fetch a specific piece of data within input data 101. When data of the input data 101 may be called by the program execution 220, the data of the input data 101 may be stored in RAM, which may prevent the data from needing to be transferred into a data file controlled by a data management system, such as the data management system 140 as described above with reference to FIG. 1. In other words, for instance and without limitation, execution code may be incapable of acting on unencrypted data, which the present method may overcome by decrypting the input data 101 as the program of the application 200 executes.

At step 220, one or more program executions of the application 200 execute while utilizing the decrypted data of the input data 101 into those processes. An execution of the program may be any form of a program function, without limitation. In some embodiments, during execution, the application 200 may extract a portion of the unencrypted input data, such as part of a file of the unencrypted input data. The execution of the program of the application 200 may produce one or more program outputs. Program outputs may include outputs similar or the same as the output data 102 as described above, but may be in an unencrypted state and stored within the internal output buffer 225 of the application 200 as described below. In some embodiments, the application 200 may place the program outputs into the original file the input data was received in.

One or more programs of the application 200 may include, but are not limited to, word processors, graphics software, database software, spreadsheet software, presentation software, web browsers, enterprise software, multimedia software, non-public customized software applications, AI/ML routines, data analytics, other cybersecurity programs, Security Information and Event Management (SIEM) programs and the like. A primary target for data protection of the current disclosure may be, for instance and without limitation, automated processes where there is limited or no user interactions. In some embodiments, the application 200 may be an automated process with limited or no user interactions.

At step 225, one or more outputs of the program execution step 220 may be stored in an internal output buffer of the application 200. In the internal output buffer, outputs from the program execution 220 may be unencrypted. At this step, program outputs stored in the internal output buffer may be utilized in various ways. For example, and without limitation, program outputs in the internal output buffer may be used for further program executions 220 within application 200 . . . . In some instantiations data stored in the internal output buffer 225 may be used to generate a new output data file 102, or the data may be placed back into an original data file 101, and the like.

In embodiments, program execution 220 of the application 200 is completed before the program output is written to an output file. Much like the internal input buffer, the data at this point may be placed in volatile RAM memory. In some embodiments, the program output can be a second virtual file associated with an ICTO which may have been represented by the input data 101. In other embodiments, the program output can be a new file created with appropriate protections which might be different than those provided by the input data. One of ordinary skill in the art, upon reading this disclosure, will appreciate the many implementations, based on the requirements for successful execution, of determining the appropriate intermediate internal storage while the program is still in process.

At step 230, the program output of the program execution of step 220 stored in the internal output buffer 225 is encrypted by the application 200 at step 230. The application 200 is still be in control of creating the final output data 102 at this step, regardless if the output data 102 originated as the input data 101, or was newly created via internal program execution 220 steps. The application 200 in some embodiments may execute a closing process to close the program output, such as in an ICTO, which encrypts the program output, leaving the program output data in a protected state. In this embodiment, the application's 200 encrypted output becomes the output data 102. In other embodiments there might not be a business or technical rationale to encrypt the output data, in those instances, at the programmers discretion the Output Data 102 could be written to a standard unprotected data file. In other words, the secondary re-encryption of the output data 102 is wholly optional. When encrypted, the output data 102 may include any form of program output as described throughout this disclosure, without limitation. Encryption may include any suitable form of encryption, such as the encryption methods described throughout this disclosure, without limitation.

Now referring back to FIG. 1. The application 120 may place the encrypted output data into an application output buffer 124. The application output buffer 124 may be external to the application 120. In some embodiments, when the application 120 closes an executed file, the executed file may automatically be saved into an application output buffer 124.

The application 120 may apply one or more protections to a data file and/or data object of the output data 102, such as in the case of the output data 102 being in a form of an ICTO. The protections placed on the output data 102 may be specified through other determinations an application developer might use to classify the output data 102. Various protection level determinations may be accomplished by another local application call bed the application 120, an application within the apparatus 100, and/or called through a remote device. The resultant output data 102 may take the form of a data file whose control is transferred from the application 120 back to a data management system, such as the data management system 140 as described above with reference to FIG. 1.

In some embodiments, the application 120 produces output data 102. The output data 102 may include one or more numbers, characters, words, symbols, values, and the like, without limitation. As a non-limiting example, the output data 102 may be in the form of a.csv file. In some embodiments, the output data 102 may be specific to the application 120. For instance, the output data 102 of the application 120 may include one or more values, characters, meta-data, and the like, that may correspond to one or more functionalities of the application 120. The application 120 may transfer the output data 102 into the application output buffer 124. The internal output buffer 124 may operate inside the application 120 and agnostic to an OS of the apparatus 100. The application output buffer 124 may be configured to store one or more characters, strings, symbols, text, and the like, similar to the application input buffer 116. The application output buffer 124 may be application specific. For instance, the application output buffer 124 may be specific to the application 120

FIG. 3 is a block diagram that illustrates an exemplary hardware architecture of a computing device 300 suitable for use, with embodiments of the present disclosure. Those of ordinary skill in the art and others will recognize that the computing device 300 may be any one of any number of currently available or yet to be developed devices including, but not limited to, desktop computers, server computers, lap top computers, embedded computing devices, application specific integrated circuits (ASICs), smartphones, tablet computers, and/or the like.

In its most basic configuration, the computing device 300 includes at least one processor 302 and a system memory 304 connected by a communication bus 306. Depending on the exact configuration and type of device, the system memory 304 may be volatile or nonvolatile memory, such as read only memory (“ROM”), random access memory (“RAM”), EEPROM, flash memory, or similar memory technology. Those of ordinary skill in the art and others will recognize that system memory 304 typically stores data and/or program modules that are immediately accessible to and/or currently being operated on by the processor 302. In this regard, the processor 302 serves as a computational center of the computing device 300 by sup porting the execution of instructions. In some embodiments, the processor 302 and the system memory 304 may be communicatively connected. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 104 may include any computing device as described in this disclosure, including without limitation a microcontroller, microprocessor, digital signal processor (DSP) and/or system on a chip (SoC) as described in this disclosure. The processor 302 may include, be included in, and/or communicate with a mobile device such as a mobile telephone or smartphone. The processor 302 may include a single computing device operating independently, or may include two or more computing device operating in concert, in parallel, sequentially or the like; two or more computing devices may be included together in a single computing device or in two or more computing devices. The processor 302 may interface or communicate with one or more additional devices as described below in further detail via a network interface device 310. Network interface device may be utilized for connecting the processor 302 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The processor 302 may include but is not limited to, for example, a computing device or cluster of computing devices in a first location and a second computing device or cluster of computing devices in a second location. The processor 104 may include one or more computing devices dedicated to data storage, security, distribution of traffic for load balancing, and the like. The processor 302 may distribute one or more computing tasks as described below across a plurality of computing devices of computing device, which may operate in parallel, in series, redundantly, or in any other manner used for distribution of tasks or memory between computing devices. The processor 302 may be implemented using a “shared nothing” architecture in which data is cached at the worker, in an embodiment, this may enable scalability of apparatus 100 and/or the processor 302.

With continued reference to FIG. 3, the processor 302 and/or a computing device may be designed and/or configured by a memory to perform any method, method step, or sequence of method steps in any embodiment described in this disclosure, in any order and with any degree of repetition. For instance, the processor 302 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 302 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

As further illustrated in FIG. 3, the computing device 300 may include a network interface 310 comprising one or more components for communicating with other devices over the network. Embodiments of the present dis closure may access basic sendees that utilize the network interface 310 to perform communications using common network protocols. In the exemplary embodiment depicted in FIG. 3, the computing device 300 also includes a storage medium 308. However, services may be accessed using a computing device that does not include means for persisting data to a local storage medium. Therefore, the storage medium 308 depicted in FIG. 3 is represented with a dashed line to indicate that the storage medium 308 is optional. In any event, the storage medium 308 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and the like.

As used herein, the term “computer readable media” includes volatile and nonvolatile and removable and nonremovable media implemented in any method or technology capable of storing information, such as computer readable instructions, data structures, program modules, or other data. In this regard, the system memory 304 and storage medium 308 depicted in FIG. 6 are merely examples of computer readable media.

Suitable implementations of computing devices that include a processor 302, system memory′ 304, communication bus 306, storage medium 308, and network interface 310 are known and commercially available. For case of illustration and because it is not important for an understanding of the claimed subject matter, FIG. 6 does not show some of the typical components of many computing devices. In this regard, the computing device 300 may include input devices, such as a keyboard, mouse, microphone, touch input device, and/or the like. Similarly, the computing device 300 may also include output devices such as a display, speakers, printer, and/or the like. Since all these devices are well known in the art, they are not described further herein.

What is claimed is:

1. An apparatus for operating system agnostic data encryption, comprising:
a processor; and
a memory communicatively connected to the processor, the memory containing instructions configuring the processor to:
receive encrypted input data for processing by an application;
store the encrypted input data in a communications input buffer, the communications input buffer being separate from the application;
execute the application, wherein the application is configured to:
move the encrypted input data from the communications input buffer to an application input buffer specific to the application;
decrypt the encrypted input data within the application to produce unencrypted data stored in an internal input buffer;
run one or more programs within the application with the unencrypted input data as an input to generate unencrypted output data;
store the unencrypted output data in an internal output buffer, the internal output buffer operating within the application;
convert the unencrypted output data into encrypted output data within the application; and
transfer the encrypted output data in an application output buffer which returns control of the now protected file back to the OS for to execute any and all preprogrammed instructions regarding the file's next destination.

2. The apparatus of claim 1, wherein the encrypted input data in the application input buffer and the encrypted output data in the application output buffer are both in protected states.

3. The apparatus of claim 1, wherein the unencrypted input data and the unencrypted output data within the application is agnostic to a native operating system (OS) of the processor.

4. The apparatus of claim 1, wherein the encrypted input data and the encrypted output data are both stored in a same protected data file.

5. The apparatus of claim 4, wherein the same protected data file is an intelligent cipher text object (ICTO).

6. The apparatus of claim 1, wherein the application is further configured to create a separate data file from a data file of the encrypted input data and store the encrypted output data in the separate data file.

7. The apparatus of claim 1, wherein the application is further configured to:
extract a portion of the unencrypted input data from a file;
run one or more programs with the portion of the unencrypted input data; and
return the portion of the unencrypted output data to the same file, which in the process re-encrypts the data.

8. A method for operating system agnostic data encryption using a computing device, comprising:
receiving encrypted input data for processing by an application;
storing the encrypted input data in a communications input buffer, the communications input buffer being separate from the application;
executing the application, wherein executing the application comprises:
receiving, at an application input buffer specific to the application, the encrypted input data from the communications input buffer;
decrypting the encrypted input data to produce unencrypted input data;
running one or more programs with the unencrypted input data to produce output data;
storing the output data in an internal output buffer, the internal output buffer operating within the application;
encrypting the output data to produce encrypted output data; and
transferring the encrypted output data in an application output buffer.

9. The method of claim 8, wherein the encrypted input data in the application input buffer and the encrypted output data in the application output buffer are both in protected states.

10. The method of claim 8, wherein receiving the encrypted input data comprises receiving the encrypted input data from an external computing device.

11. The method of claim 8, wherein receiving the encrypted input data comprises receiving the encrypted input data from a local storage device.

12. The method of claim 8, wherein unencrypted input data and the output data within the application are agnostic to a native operating system (OS) of the processor.

13. The method of claim 8, wherein the encrypted input data and the encrypted output data are both stored in a same protected data file.

14. The method of claim 13, wherein the file is an intelligent cipher text object (ICTO).

15. The method of claim 8, wherein running the one or more programs further comprises creating a separate data file from a data file of the encrypted input data and storing the encrypted output data in the separate data file

16. The method of claim 8, wherein running the one or more programs further comprises:
extracting a portion of the unencrypted input data from a file;
running one or more programs with the portion of the unencrypted input data; and
returning the portion of the unencrypted input data to the file.

17. The method of claim 8, wherein running the one or more programs further comprises generating a virtual file from the unencrypted input data and running one or more programs with the virtual file.

18. The method of claim 17, further comprising storing the virtual file in random access memory (RAM).
